(19) United States
(12) Patent Application Publication
(10) Pub. No.: US 2004/0087375 A1
(43) Pub. Date: May 6, 2004

(54) Electronic device for gaming chips

(76) Inventor: Emmanuel Gelinotte, Beaune (FR)

Correspondence Address: GREENBLUM & BERNSTEIN, P.L.C., 1950 ROLAND CLARKE PLACE, RESTON, VA, 20191, US

(21) Appl. No.: 10/467,331

(22) PCT Filed: Nov. 29, 2002
(86) PCT No.: PCT/FR02/04112

(30) Foreign Application Priority Data
Dec. 3, 2001 (FR) 01/15576

(51) Int. Cl. G06F 17/00

(52) U.S. Cl. 463/47

(57) ABSTRACT

The storage device for gaming chips with a memory electronic circuit includes a tray with a plurality of columns adapted to receive stacked chips and equipped with antennas associated with an electronic unit able to communicate in read/write mode with the chips in each column. Each antenna includes a ferrite rod surrounded by a conductive wire coil and having at each end two plane ferrite lugs lying in a plane substantially perpendicular to the rod to form a wide V-shape, the free ends of the lugs being disposed face-to-face in pairs at the two ends of two adjacent columns.

The present invention relates to storing gaming chips, also referred to as casino chips. The expression “gaming chip” means any disk-shaped or plate-shaped article representing a value, possibly a nominal value. Chips are generally fabricated from rigid and scratch-resistant plastics materials and carry patterns varying in design and color to form a more or less complex decoration to reduce the risk of falsification and/or fraudulent reproduction. Some chips incorporate an electronic circuit including a memory for storing information concerning the chip, in particular a number or an identifier and its numerical value. Chips equipped with electronic circuits including a memory are also referred to as “electronic memory chips” and “electronic circuit chips”. Different designs of chips have electronic circuits including PROM, EEPROM, or even microprocessors with associated memory.

The invention relates more particularly to storing chips with an electronic memory in a chip rack that can be placed on or incorporated in a gaming table, for example. Chip racks or trays of this kind are used to store reserves of chips at cashier's windows and/or gaming tables. The rack contains chips exchanged for money, for example chips or plates with different face values, cash, etc. It is also possible to take from the rack the chips necessary to pay out winning plays and to put into the rack chips collecting from losing plays. The number of chips in a rack varies and consequently the overall value of the chips evolves over time.

To facilitate monitoring the chips contained in the rack and in and out movements of the chips, in order to achieve better control of those movements and thereby combat fraud more effectively, patent application WO 97/30414 in the name of the applicant proposes devices for storing gaming chips incorporating an electronic circuit including a memory having a similar storage structure provided with at least one columnar storage section, referred to hereinafter as a column, adapted to receive chips, and a dialog electronic unit including chip memory reading means able to communicate via antenna means with the chips present in at least one column of said storage structure. Anticollision algorithms enable the dialog unit to simultaneously read and write all the chips in a column on the rack/tray. A first variant of the electronic storage device includes antennas with wide plane loops surrounding the columns of chips; in a second variant antennas in the form of circular coils with an optional ferrite core are disposed at the bottom end of the columns.

Although yielding the expected results in terms of reliability and security, the two variants of the electronic storage device disclosed in the patent application previously cited are limited, in terms of the maximum number of chips that can be read in a column, to around twenty chips in the case of conventional circular chips approximately 4 mm thick.

These quantitative limitations are something of a problem for casino operators using racks or trays with columns having a high capacity able to accommodate from 60 to 80 chips. What is more, merely expanding the geometry of the prior art antennas does not yield good results in terms of the number of chips that can be read or in terms of the geometrical dimensions of the racks and/or trays, which become incompatible with the gaming tables or changing tables used in casinos.

An object of the invention is to propose high-capacity electronic devices for storing chips adapted to eliminate or at least significantly reduce the drawbacks explained above.

To this end, the invention proposes a storage device for chips including an electronic circuit including a memory, said device comprising a storage structure provided with at least one columnar storage section, hereinafter referred to as a column, adapted to receive chips, and a dialog electronic unit including means for reading the memory in the chips to communicate via antenna means with the chips present in at least one column of said storage structure, the device being characterized in that the antenna means include at least one coil antenna comprising a ferrite rod partly or wholly surrounded by a coil and having at each end at least one plane ferrite lug lying in a plane substantially perpendicular to the rod, the lugs being disposed face-to-face in pairs in whole or in part at the two ends of at least one column.

As explained in detail in the following description, the geometry of the ferrite structure of the antenna integrated into the storage device according to the invention concentrates a high magnetic field between the two facing lugs in an axial area of the column and over a distance substantially equal to the length of the ferrite rod. This antenna structure improves the chip read/write performance of the antenna and increases the capacity of the casino chip tray columns; tests have shown that columns of 100 chips are possible.

In a first embodiment of the invention, each end of said ferrite rod is associated with a plurality of lugs disposed substantially symmetrically relative to a plane passing through said rod or relative to the rod axis. This feature means that the same antenna can read a plurality of adjoining and/or adjacent columns of chips. This simplifies the electronic storage device physically and electronically, and improves its efficiency, as well as achieving a reduction in overall size by facilitating integration of the antennas into the trays.

In a first variant, the plurality of lugs comprises two lugs that are either aligned or disposed in a U-shape or a V-shape. This variant is used with a storage structure having a substantially plane arrangement of parallel columns, the columns being associated two by two with an antenna and disposed on either side of the corresponding rod, the free ends of the lugs being substantially aligned with the central regions of two adjacent columns.

Said storage structure optionally includes at least one wide column disposed in two antennas having projecting lugs substantially aligned with the lateral regions of said wide column. This arrangement allows rectangular gaming plates to be read in addition to conventional disk-shaped chips.

Said tray type storage structure advantageously has on its upper face a chip receptacle tray comprising parallel columns for chips separated from each other by rectilinear walls, the antenna rods being disposed under said walls, preferably relatively close to the bottom of the columns.

In one simple, robust, and modular embodiment, the storage structure includes a frame carrying the antennas and adapted to receive the chip receptacle tray, removably or otherwise.

In another variant, said plurality of lugs comprises equi-angularly distributed lugs radiating about the rod axis, which is vertical. This variant can be used with a rack having a carousel type storage structure with a vertical tubular well in which said rod is disposed.

It is to be understood that in the remainder of the description, in the context of the invention, the term “rack” encompasses any kind of carrier of columns of chips or plates, including trays with horizontal or slightly inclined columns and vertical dispensing racks.

In one high performance embodiment of the invention, the dialog electronic unit communicates with the chips in a “contactless” mode by means of modulated waves via antenna means that include at least one antenna associated with said reading means and are disposed relative to the storage structure to provide communication with the chips present in at least one column of said structure.

The dialog unit advantageously includes means for writing the memory of chips in the column of the storage structure.

The dialog electronic unit and the memory electronic circuit of the chips are advantageously adapted to enable the dialog unit to discriminate between chips in the same column.

It is therefore possible for the dialog electronic unit, by communicating with the memory of each of the chips, to determine in real time the number of electronic memory chips contained in the storage structure, the value of each chip, the overall total value contained in the rack or tray, the identity of each chip, the value per denomination, or any other associated information, for example the identity of the chip. This information can be stored, processed in real time, or transmitted via a network to a server for carrying out all required analyses and processing.

One advantage of the electronic storage device according to the invention is that the reading capacity of a single antenna (up to 2×100 chips) reduces the number of antennas per tray, avoids a multiplicity of antennas per column, and very considerably simplifies the physical structure and the electronics of the storage device, including its electronic equipment.

The invention also provides an antenna for use in an electronic device for storing flat chips, plates or like objects incorporating memory electronic circuits, which antenna is characterized in that it includes a ferrite rod surrounded in whole or in part by a conductive wire coil and having at each end at least one plane ferrite lug lying in a plane substantially perpendicular to the rod, the lugs being disposed face-to-face in pairs, in whole or in part, at the two ends of at least one column storage structure adapted to receive flat chips, plates or like objects incorporating memory electronic circuits.

Each end of said ferrite rod is advantageously associated with a plurality of lugs disposed substantially symmetrically with respect to a plane passing through said rod or with respect to the rod axis. In particular, said plurality of lugs includes two lugs that are either aligned or disposed in a U-shape or a V-shape.

Other aims, advantages and features of the invention will become apparent on reading the following description of embodiments of a storage device in accordance with the invention for gaming chips of the type incorporating an electronic memory, which description is provided by way of nonlimiting example and with reference to the accompanying drawings, in which:

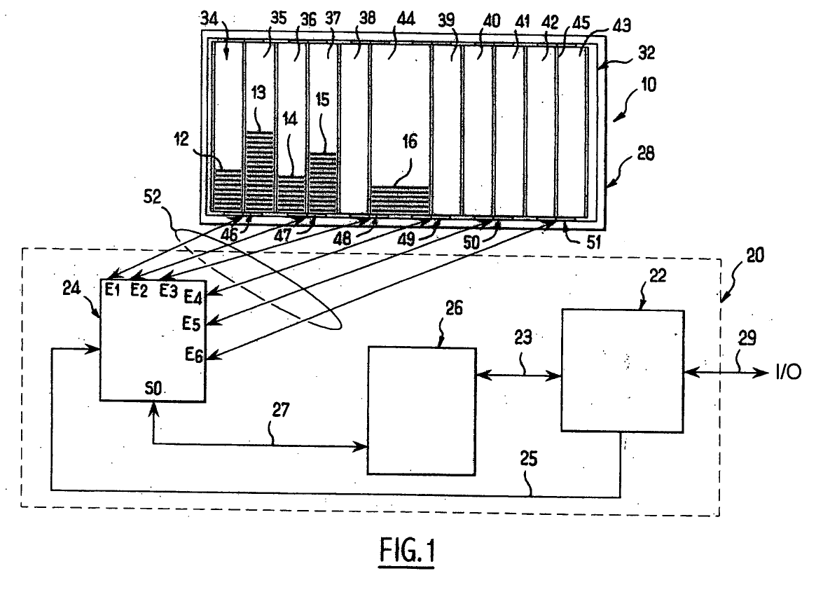

FIG. 1 is a diagrammatic representation of an electronic storage device for chips in accordance with the invention, including the associated electronic equipment;

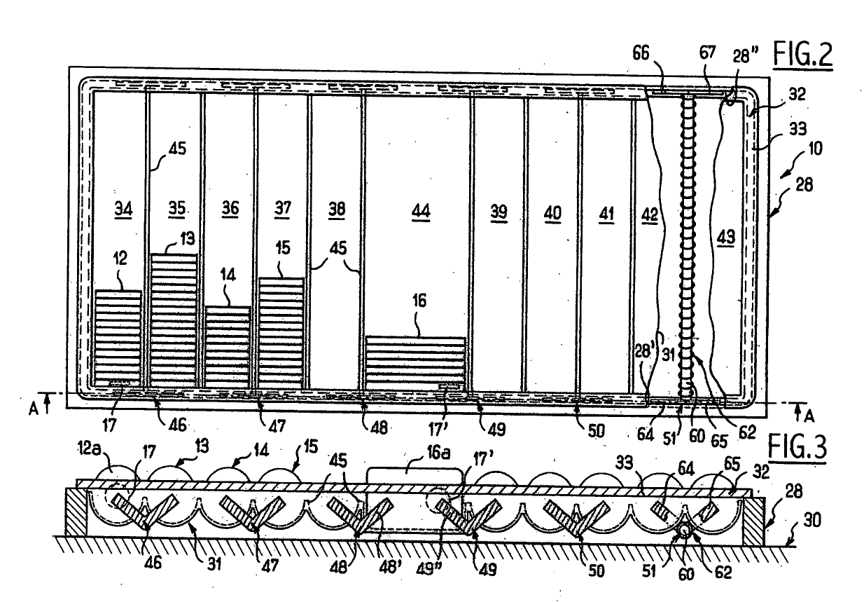

FIG. 2 is a diagrammatic plan view to a larger scale of the storage tray structure shown in FIG. 1;

FIG. 3 is a diagrammatic side view of the tray storage structure in section taken along the line AA in FIG. 2; and

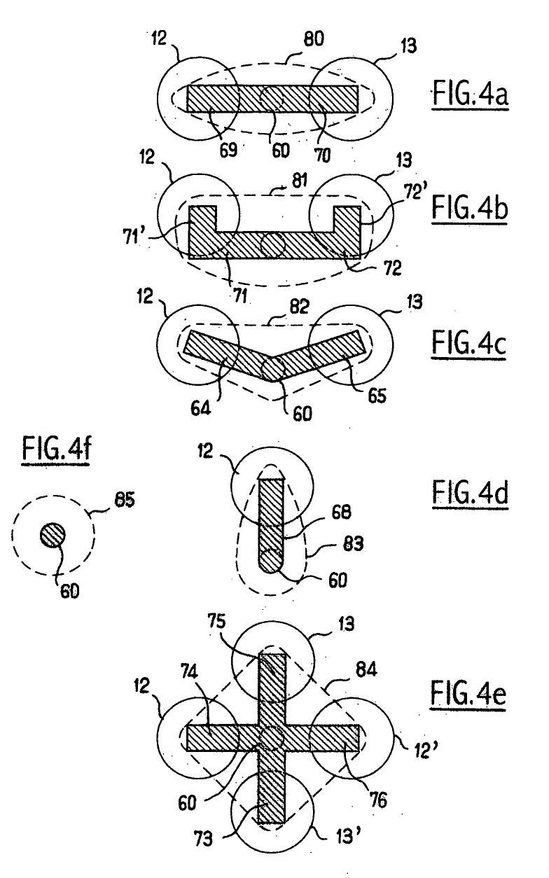

FIGS. 4a to 4f are diagrammatic side views of variants of the antennas and the ferrite rods that can be used in the context of the present invention.

The device for storing gaming chips in accordance with the invention shown in FIG. 1 essentially includes a storage structure 10 for gaming chips adapted to accommodate chips stored in stacks 12, 13, 14 and 15 (or gaming plates 16) and a read/write dialog electronic unit 20 associated with antenna means consisting of six separate loop antennas 46 to 51 whose two terminals are connected by a multiple two-wire line 52 to the double inputs E1 to E6 of a multiplexer card 24 forming a sequential antenna selection interface and whose output SO is connected by a bidirectional line 27 to a read/write electronic circuit card 26 including means for reading the memory of the chips and means for writing the memory of the chips both controlled by a microprocessor-based processor unit 22, which in this example is a personal computer (PC). The processor unit controls the read/write card 26 via the line 23 and the multiplexer card 24 via the line 25. The processor unit 22 communicates conventionally with the outside world (display peripheral, keyboard, modem, network interfaces, server, etc.) via input/output (I/O) lines 29. Without departing from the scope of the invention, a simplified version of the dialog electronic unit includes only means for reading the memory of the chips, its structure and its operation being similar to what is described hereinafter for the read/write unit 26.

The processor unit 22, in this example a PC, controls the antenna selection interface 24 by sending signals on the line 25 when a plurality of antennas is used. The computer 22 includes a time and date circuit for marking the date and time of each event, EEPROM for storing data exchanged with the electronic chips, and an I/O interface 29 for a connection with a server computer (not shown), either in point-to-point mode or in network mode. The computer 22 is normally equipped with a keyboard and a display screen. For example, the keyboard is used to enter into the system information such as commands to open and/or close the gaming table with which the rack is associated, to enter the name of the operator, and so on. Similarly, the screen can display some or all of the following information: the total number of chips present in the rack, the number of chips of each denomination and/or in each column, the total value contained in a column and/or in the rack.

The read/write card 26 includes a microprocessor which generates and interprets signals exchanged with the electronic memory chips and an oscillator which generates the carrier frequency (for example 125 kHz) of the radio frequency signal fed to the antennas. The card 26 also contains an analog-to-digital converter (ADC), a modulator and an amplifier. In accordance with commands and information from the computer 22, the card 26 generates an amplitude modulated radio frequency analog signal which conveys energy, data and a synchronization signal to the electronic memory chips via the selected antenna. The electronic chips and plates 12-16 are passive (i.e. they have no internal energy store) and of the read-only or read-write type. The antenna must therefore supply the energy needed for the electronic circuit of the chip to function and must also transmit data. The antenna/chip working distances are defined as a function of the magnetic flux necessary for correct functioning of the electronic circuit of the chip and therefore depend on the inductance and the geometry of the antenna and the current flowing in antenna. In this example, internal circular coil antennas are used for the electronic circuit chips.

The chip storage structure 10 shown in more detail in FIGS. 2 and 3 comprises a rectangular frame 28 adapted to be placed on a support (for example the top 30 of a gaming table, a changing table, a banking table or the like, shown partly in FIG. 3), which is horizontal and flat or slightly inclined toward the front, i.e. toward the operator.

The frame 28 is made from a non-metallic material, for example a rigid plastics material, and carries a chip receptacle in the form of a tray 32, which is also made of a plastics material and in this example is removable, essentially consisting of a bottom 31 flanked by an integral rectangular stiffener 33 conferring the necessary rigidity on the tray. The columnar storage sections or parallel columnar storage sections are defined in the bottom 31, and in this example there are two groups of five columns 34, 35, 36, 37, 38 and 39, 40, 41, 42 with a semicylindrical section for the stacks 12, 13, 14 and 15 of disk-shaped chips and a quasi-rectangular section center column 44 for the stack 16 of substantially rectangular plates, the columns being separated by straight separating walls 45.

The frame 28 also carries six antennas 46 to 51 each controlling two columns of the tray 32 and associated with the dialog electronic unit 20. The antennas 46 to 51 are described in detail later. Depending on the choice of the casino using it, the tray 32 can be removable from the frame 28 or not, or the tray 32 can be fastened to the frame 28 to form an assembly that is removable or not from the supporting table 30 (if the frame 28 is removably mounted on the table 30, electrical connection/disconnection means for the multiple line 52 between the antennas 46 to 51 carried by the frame 28 and the multiplexing card 24 are provided).

The invention makes use of improved gaming chips and/or plates incorporating a contactless identification electronic device. To be more precise, each chip or plate (for example the chip 12a or the plate 16a) includes an electronic circuit 17 or 17′ whose memory contains coded information specific to the chip to enable it to be identified and authenticated by an appropriate reader unit (a read-only unit or a read/write unit operating in read mode). The simplest version of the electronic circuits (not shown) of the chips are microcircuits with a non-reprogrammable memory (for example PROM) and have a single identification code of 32 or 64 bits whose fields can contain the serial number of the chip or a batch of chips, the nominal value, and other information such as the name of the casino, and so on.

Regardless of the type of memory used in the chip, the identification electronic circuit 17 of the chip further includes a transceiver with a peripheral circular coil antenna also embedded in the chip 12a and adapted to be powered by inductive coupling from the external antenna of the read or read/write unit, and in the context of the present invention this means the antenna 46 associated with the dialog electronic unit 20.

A more sophisticated version of the chips allows the codes to evolve and is equipped with reprogrammable memory (for example EEPROM) which can be read and written. The ability to modify the information contained in the memory makes the electronic chip more secure, in particular by enabling the authentication parameters to be changed. Similarly, it is possible to personalize some areas of the memory and then to configure them, reversibly or otherwise in a defined memory area mode, either read-only memory area mode or read/write memory area mode. In an even more sophisticated version, the chip is equipped with a microprocessor that can carry out processing and complex transactions. The dialog between the electronic unit and the chip is optionally authorized only after mutual authentication, by entering password and/or cryptography key type codes in the chip and the electronic unit (in particular for encrypting data during its transfer between the electronic unit and the chip).

In other respects, the electronic circuit in the chips is adapted either to read and/or write a plurality of chips simultaneously or to discriminate between the chips, so as to operate on stacked gaming chips or plates. In the embodiment of the invention described here by way of nonlimiting example, the dialog unit 20 integrating the discrimination function, in particular on the card 26, is adapted to enter the identity of a first chip in a batch of chips situated in the field radiated by the active antenna, for example the two stacks of chips in columns 34 and 35 on the tray 32 controlled by the antenna 46. It is then possible to dialog with the first chip, carry out the required reading and/or writing operations, and then deactivate the captured chip by sending it a standby command. The dialog unit 20 continues to search for other chips in the working area of the active antenna 46 to capture all of the chips present in succession. After the capture and/or processing of the last chip, the dialog unit 20 sends a command to reactivate all of the chips in the two columns 34 and 35 in order to move on to another antenna, until all of the chips and plates present on the tray 32 have been read (including elimination of duplications on reading the stack of plates 16). This chip discrimination function is also referred to as an anticollision function.

The structure and fabrication of the electronic circuit chips with memory are not described in detail here. The application EP-A-0694872 in the name of the applicant discloses, by way of nonlimiting example, a plurality of chip and plate structure types that can be used in the context of the present invention. Similarly, the application WO 97/30414 previously cited includes additional information on the general operation of electronic devices for storing gaming chips.

Turning to FIGS. 2 and 3, the antenna means comprise six antennas 46, 47, 48, 49, 50 and 51 that are substantially identical and are mounted on the frame 28 under the separating walls 45 between the columns 34-35, 36-37, 38-44, 44-39, 40-41 and 42-43, fairly close to the bottom 31 of the corresponding columns. As can be seen in FIG. 2, in which the bottom 31 is partly cut away to show the antenna 51 disposed symmetrically between the columns 42 and 43, each antenna, in this example the antenna 51, comprises a ferrite rod 60 surrounded wholly or in part by a cylindrical coil 62 of conductive wire electrically connected to one of the input lines 52 of the multiplexer card 24 (in this example its input E6), the rod 60 having at each end two plane ferrite lugs 64, 65 and 66, 67, which are preferably in one piece, lying in a plane substantially perpendicular to the rod and disposed in facing pairs 64-66 and 65-67, respectively, in parts (their free ends) at the two ends of the columns 42 and 43. The rod 60 and the lugs 64, 65 and 66, 67 are fixed to the frame 28 by any appropriate means, generally by gluing them to the facing interior faces 28′ and 28″. In the particular embodiment of the antennas 46-51 shown in FIGS. 2 and 3, the two end lugs form a wide V-shape subtending a large angle to raise the chip reading area relative to the rod 60 (so that the free ends of the lugs 64-66 and 65-67 are respectively aligned with the center areas of the columns 42 and 43, with which the antennas of the memory electronic devices 17 of the chips present in the semicylindrical columns are also more or less aligned). In practice, the angle subtended by the V-shape can be large or small and the length of the lugs can be chosen as a function of the geometrical dimensions of the tray 32 and the frame 28 and the space available in particular for placing the antenna rods 60 under the tray 32.

FIG. 4 also shows that the magnetic field between the facing lugs tends to widen because of the shape of the ends with V-shaped double lugs (see FIG. 4c, dashed line 82), in particular compared to aligned double lugs (FIG. 4a, dashed line 80). In connection with electronic capture (reading and/or writing) of the plates 16, two lateral antennas are provided (in this example the right-hand lug 48′ of the antenna 48 and the left-hand lug 49″ of the antenna 49) to enable communication (in this example via the antenna 49) with the memory electronic circuit 17′ regardless of its position in the plate 16, the unit 22 including an algorithm for eliminating duplicated input.

By way of nonlimiting example, the ferrite rods 60 used have a diameter in the order of 1.3 cm and a length of approximately 22.5 cm. This length of the rods 60 enables reading/writing of 60 chips approximately 3.8 mm thick per column. The ferrite lugs have a length of approximately 3 to 4 cm, a width in the order of 1 cm and a thickness in the order of 0.25 cm. The lugs are generally glued to the rods. The ferrites have characteristics corresponding to the frequency range of the transponders (125 kHz in this example) and a permeability from 100 to 250. The losses caused by the ferrites must remain low to minimize the equivalent resistance of the antenna (for an antenna for reading/writing two columns of 60 chips, the equivalent resistance must remain below 20 Ohms).

In connection with the duration of transactions, the performance that can be obtained from the storage device according to the invention with existing 125 kHz technology components is of the order of about ten seconds to capture two columns of 60 stacked chips. Of course, without departing from the scope of the present invention, the shape, number, disposition and location of the antennas of the dialog unit and the antenna selection interface can be adapted as a function of fabrication constraints and/or diverse specifications set by casino operators.

The invention also relates to racks, trays, vertical dispensers, carousels and other equipment for storing columns of gaming chips, gaming plates or the like adapted to be used in a storage device according to the invention, in particular racks and trays equipped with antennas for capturing columns of chips of the type with a ferrite rod carrying a coil and having facing ferrite lugs at the ends.

The invention also relates to coil antennas with ferrite rods and facing ferrite lugs intended for use in an electronic storage device for chips, plates or similar flat objects with electronic circuits including memory, in which device these objects with electronic circuit are stored in columns. Once again, without departing from the scope of the present invention, the shape, number, disposition and location of the antennas relative to the dialog unit and the antenna selection interface can be adapted as a function of fabrication constraints and/or diverse specifications set by users.

FIGS. 4a to 4e are side views of variants of antennas (the coils are not shown) that can be used in the context of the present invention, which are described by way of nonlimiting example. Each figure shows in dashed line the cross section of the rod 60, the ferrite lug or lugs at its ends, the silhouettes of the columns of chips 12, 12′, 13, 13′, and a field curve representative of the profile of the envelope of the magnetic field radiated either by the rod alone (see FIG. 4f, dashed line circle 85) or the various structures with ferrite lugs (dashed field curve 80, 81, 82, 83, 84 and 85), the magnetic field lines adjacent the rods 60 lying substantially parallel thereto and perpendicular to the plane of FIGS. 4a to 4f.

FIG. 4f shows the profile 85 of the field radiated by the rod 60 alone. This profile is not suitable for reading/writing (electronic capture) of a gaming chip or plate. The purpose of the additional lugs, which have various sizes and/or shapes, is to modify the symmetry of the antenna and/or the shape of the magnetic field so as to reach the central portion of the column of chips (area of alignment of the antennas of the chips) and to conform the antenna according to the space available between the tray 32 and the frame 28.

FIG. 4a shows the disposition of an antenna with aligned double lugs 69, 70 with a field curve 80 that is eccentric relative to the rod 60 and slightly narrowed at the free ends of the lugs. The same phenomenon is seen in FIG. 4d where the curve 83 is narrowed at the end of the lug 68 of a single-lug antenna. In practice, this narrowness is not a real problem for reading chips.

FIGS. 4b and 4c show the dispositions of two antennas with double lugs, respectively a ferrite structure with elbow-bend lugs 71-71′, 72-72′ in which the two elbow bends 71′ and 72′ in line with the columns of chips 12 and 13 are disposed face-to-face to form a U-shape with a wide base and the wide V-shape structure subtending a large angle and with the lugs 64 and 65 described previously. Note that in both cases the curves 81 and 82 are wider at the free ends of the lugs.

Likewise the curve 84 shown in FIG. 4e, in which the ferrite structure includes four end lugs 73, 74, 75 and 76 in a cruciform arrangement, equi-angularly distributed around the axis of the rod 60, and at a right angle to each other. This latter type of antenna is used in racks and carousels with vertical columns.

1. A storage device for chips including an electronic circuit including a memory, said device comprising a storage structure (10) provided with at least one columnar storage section (34, 42, 43), hereinafter referred to as a column, adapted to receive chips (12), and a dialog electronic unit (20) including means for reading the memory in the chips to communicate via antenna means (46-51) with the chips present in at least one column (34) of said storage structure, the device being characterized in that the antenna means (46-51) include at least one antenna of the coil type comprising a ferrite rod (60) partly or wholly surrounded by a conductive wire coil (62) and having at each end at least one plane ferrite lug (64-67) lying in a plane substantially perpendicular to the rod, the lugs being disposed face-to-face in pairs (64, 66; 65, 67) in whole or in part at the two ends of at least one column (42, 43).

2. A device according to claim 1, characterized in that each end of said ferrite rod (60) is associated with a plurality of lugs (64-67) disposed substantially symmetrically relative to a plane passing through said rod or relative to the rod axis.

3. A device according to claim 2, characterized in that said plurality of lugs comprises two aligned lugs (69, 70) or two lugs disposed in a U-shape (71, 72) or two lugs disposed in a V-shape (64, 65).

4. A device according to claim 3, characterized in that said storage structure (10) features a substantially plane arrangement of parallel columns (34-44) associated in pairs with an antenna (46-51) and disposed on either side of the corresponding rod, the free ends of the facing lugs (64, 66; 65, 67) each being substantially in alignment with respective central regions of the two columns.

5. A device according to claim 4, characterized in that said structure (10) includes at least one wide column (44) disposed in two antennas (48, 49) having projecting lugs substantially aligned with the lateral regions of said wide column (44).

6. A device according to either claim 4 or claim 5, characterized in that said storage structure (10) includes a chip receptacle tray (32) comprising parallel columns for chips (34-44) separated from each other by rectilinear walls (45), the antenna rods (60) being disposed under said walls, preferably relatively close to the bottom (31) of the columns.

7. A device according to claim 6, characterized in that the storage structure (10) includes a frame (28) carrying the antennas (46-51) and adapted to receive the chip receptacle tray (32), removably or not.

8. A device according to claim 2, characterized in that said plurality of lugs comprises equi-angularly distributed lugs (73-76) radiating about the rod axis.

9. A device according to any preceding claim, characterized in that the dialog electronic unit (20) communicates with the chips (12) in a “contactless” mode by means of modulated waves via antenna means (46-51) that include at least one antenna (46) associated with said reading means and are disposed relative to the storage structure to provide communication with the chips present in at least one column (34) of said structure.

10. A device according to any preceding claim, characterized in that the dialog electronic unit (20) includes means for writing into the memory of chips in said column (34) of said structure (10).

11. A device according to any preceding claim, characterized in that the dialog electronic unit (20) and the memory electronic circuits of the chips are adapted to enable the dialog unit (20) to discriminate between chips (12) in the same column (34).

12. A device according to any preceding claim, including a plurality of antennas (46-51), characterized in that the dialog electronic unit (20) includes sequential antenna selector means (24).

13. An antenna (46-51) for use in an electronic storage device for flat chips, plates or like objects incorporating memory electronic circuits according to any preceding claim, which antenna is characterized in that it includes a ferrite rod (60) surrounded in whole or in part by a conductive wire coil (62) and having at each end at least one plane ferrite lug lying in a plane substantially perpendicular to the rod, the lugs (64-67) being disposed face-to-face in pairs (64, 66; 65, 67), in whole or in part, at the two ends of at least one column storage structure (42, 43) adapted to receive flat chips, plates or like objects incorporating memory electronic circuits.

14. An antenna according to claim 13, characterized in that each end of said ferrite rod (60) is associated with a plurality of lugs (64-67) disposed substantially symmetrically with respect to a plane passing through said rod or with respect to the rod axis.

15. An antenna according to claim 14, characterized in that said plurality of lugs includes two lugs that are either aligned (69, 70) or disposed in a U-shape (71, 72) or a V-shape (64-67).

16. An antenna according to claim 14, characterized in that each end of said ferrite rod (60) is associated with a plurality of equi-angularly distributed lugs (73-76) radiating around the rod axis.
